(19) United States
(12) Patent Application Publication
(10) Pub. No.: US 2004/0156381 A1
(43) Pub. Date: Aug. 12, 2004

(54) Partial queuing using an interface with bounded latency

(76) Inventors: Michael Andrew Fischer, San Antonio, TX (US); Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/611,304

(22) Filed: Jul. 1, 2003

Related U.S. Application Data
(60) Provisional application No. 60/446,339, filed on Feb. 10, 2003.

(51) Int. Cl. H04L 12/54

(52) U.S. Cl. 370/429; 370/412

(57) ABSTRACT

A technique is disclosed for queuing frames that are to be transmitted. The illustrative embodiment enables partial queuing of portions of frames on the part of a receiving entity, requiring only a minimum of real-time response on the part of the sending entity once the start of a frame is queued by the receiving entity. The illustrative embodiment relaxes queue memory requirements by recognizing that the interface between the sending entity and the receiving entity is able to respond to a request from the receiving entity to fetch additional frame data before the data presently in the partial queue is consumed. The amount of data that needs to be stored in each partial queue entry is causally related to a bounded latency time of the upper-to-lower layer interface multiplied by the physical layer rate of the transmitted frame.

### CROSS-REFERENCE TO RELATED APPLICATIONS

This application claims the benefit of U.S. Provisional Patent Application Serial No. 60/446,339, entitled “Partial Queuing Using an Interface with Bounded Latency,” filed on Feb. 10, 2003 (Attorney Docket: 680-050US), which is incorporated by reference.

### FIELD OF THE INVENTION

The present invention relates to telecommunications in general, and, more particularly, to a communications station that is transmitting information into a shared-communications channel.

### BACKGROUND OF THE INVENTION

FIG. 1 depicts a schematic diagram of telecommunications system 100 in the prior art. Telecommunications system 100 (e.g., a local area network, etc.) transmits signals that represent data between communication stations 101-1 through 101-P, wherein P is a positive integer, over shared-communications channel 102. Because stations 101-1 through 101-P share shared-communications channel 102, they have to follow rules (or “protocols”) that govern, among other things, when and for how long they can each use the channel.

Each of stations 101-1 through 101-P has to store (or “buffer”) the data in one or more local memories before the data can be transmitted. From a hardware cost perspective, the size of the local data buffer memory should be as small as possible. From a performance perspective, however, and especially for Quality of Service (QoS) performance, it is often necessary to maintain outgoing frames of data in a plurality of priority queues, with at least the data at the heads of each of these queues being in a state of readiness for transmission. This is especially important in polled protocols such as the 802.11e Hybrid Coordination Function (HCF) Polled Access mode, the 802.11 Point Coordination Function (PCF), and 802.15.3. Each of these medium access control protocols utilizes a coordinator that can poll a station at arbitrary times, and the station must be able to respond by transmitting a frame of a designated priority and size within a very short time interval after receipt of every such poll. All of these factors add to the size and, therefore, cost of memory.

Therefore, the need exists for a technique for that enables the stations in a telecommunications system to queue frames without the costs associated with queuing in the prior art.

### SUMMARY OF THE INVENTION

The present invention provides a technique for queuing frames for transmission without some of the costs associated with queuing in the prior art. Specifically, the present invention provides a technique that enables partial queuing of portions of frames and that requires only a minimum of real-time response on the part of the sending entity once the start of a new frame is queued by the receiving entity.

Typically, the capacity of a data buffer for a plurality of queues is greater than the frame size(s) multiplied by the number of queues. The present invention, however, relaxes the capacity requirements for a multiple-queue data buffer by recognizing that the interface between the sending entity, or “upper layer entity,” and the receiving entity, or “lower layer entity,” is able to respond to a request from the lower layer entity to fetch additional frame data before the data presently in the partial queue is consumed. The amount of data that needs to be stored in each partial queue entry is causally related to the latency time, which is bounded, of the upper-to-lower layer interface multiplied by the physical layer rate of the frame that is transmitted into a shared-communications channel.

An illustrative embodiment of the present invention comprises: storing a description of a first frame wherein the description comprises 1) a frame length and 2) a first transmission rate; receiving a first portion of the first frame wherein the length of the first portion is less than the frame length and is based on the first transmission rate; queuing the first portion of the first frame; transmitting the first portion of the first frame at the first transmission rate into a shared-communications channel; and receiving a second portion of the first frame after the transmission of the first portion has started.

### BRIEF DESCRIPTION OF THE DRAWINGS

FIG. 1 depicts a schematic diagram of telecommunications system 100 in the prior art.

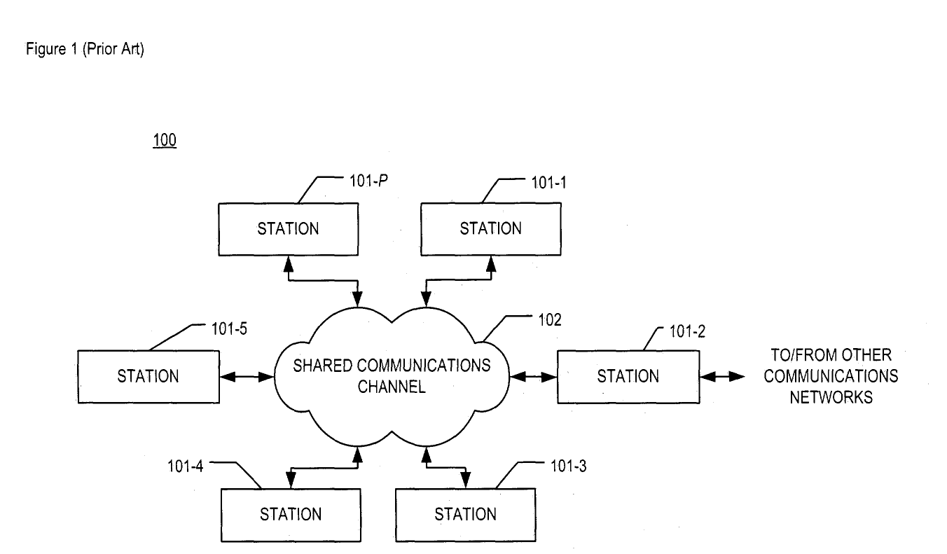

FIG. 2 depicts a block diagram of the salient components of a station in accordance with the illustrative embodiment of the present invention.

FIG. 3 depicts a block diagram of the salient components of lower layer entity 202 in accordance with the illustrative embodiment of the present invention.

FIG. 4 depicts a block diagram of the salient components of memory 305 in accordance with the illustrative embodiment of the present invention.

FIG. 5 depicts a flowchart of the illustrative embodiment of the present invention.

### DETAILED DESCRIPTION

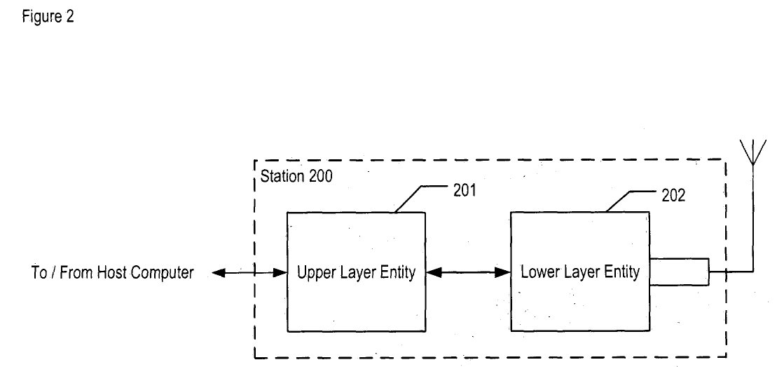

FIG. 2 depicts a block diagram of the salient components of an IEEE 802.11 station in accordance with the illustrative embodiment of the present invention. Station 200 is capable of receiving a succession of frames from a host computer and from a shared-communications channel. Station 200 is also capable of transmitting a succession of frames to a host computer and to a shared communications channel.

Station 200 comprises: upper layer entity 201 and lower layer entity 202, interconnected as shown. Upper layer entity 201 processes the upper level of medium access control for each frame, as visible to station 200. In the transmit direction, upper layer entity 201 responds to requests from lower layer entity 202 for data and information, and sends data and information to lower layer entity 202. Lower layer entity 202 processes the lower level of medium access control for each frame, as visible to station 200. It will be clear to those skilled in the art, after reading this specification, how to make and use upper layer entity 201 and lower layer entity 202.

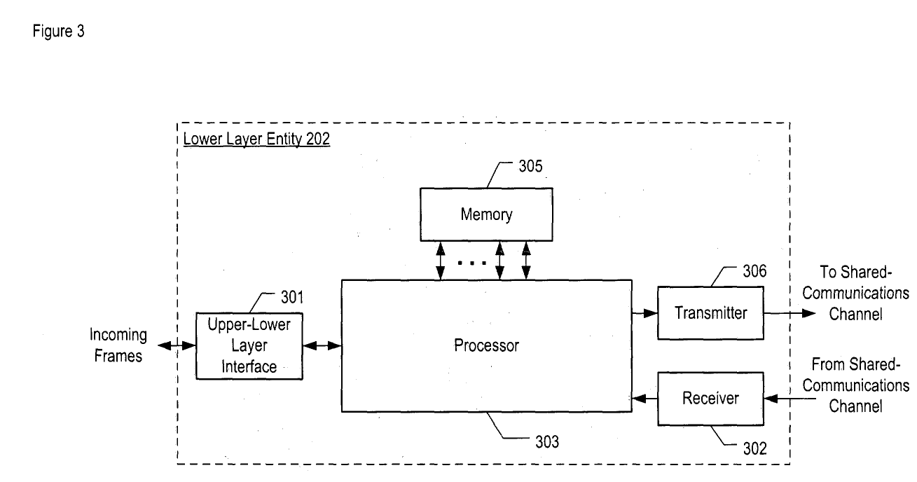

FIG. 3 depicts a block diagram of the salient components of lower layer entity 202, in accordance with the illustrative embodiment of the present invention. Lower layer entity 202 comprises: upper-lower layer interface 301, receiver 302, processor 303, memory 305, and transmitter 306, interconnected as shown.

Upper-lower layer interface 301 is an interface controller circuit that is capable of receiving data and instructions from upper layer entity 201 and of forwarding them to processor 303. Furthermore, upper-lower layer interface 301 enables lower layer entity 202 to send data and status indicators to upper layer entity 201. It will be clear to those skilled in the art, after reading this specification, how to make and use upper-lower layer interface 301.

Receiver 302 is a circuit that is capable of receiving frames from the shared-communications channel, in well-known fashion, and of forwarding them to processor 303. The frames include both data frames and control frames, such as request-to-send, clear-to-send, and acknowledgement frames.

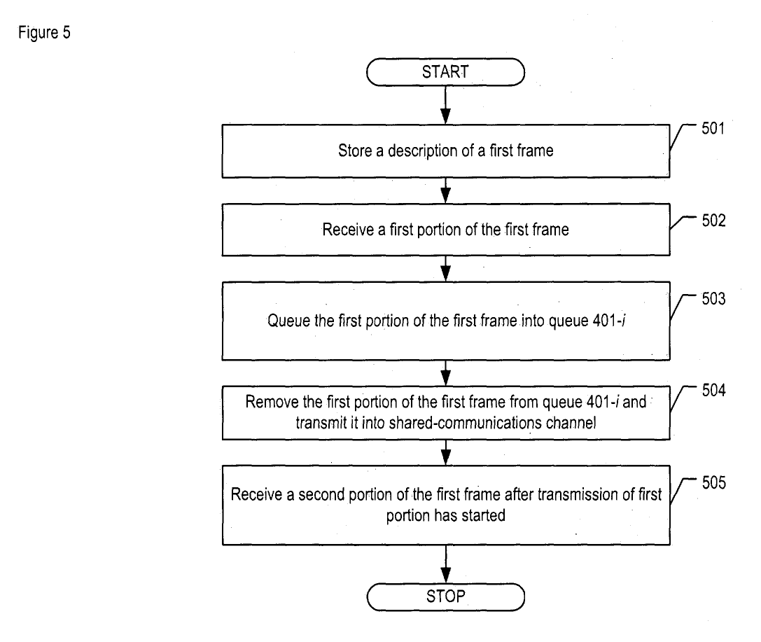

Processor 303 is a general-purpose processor that is capable of performing the tasks described below and with respect to FIG. 5. It will be clear to those skilled in the art, after reading this specification, how to make and use processor 303.

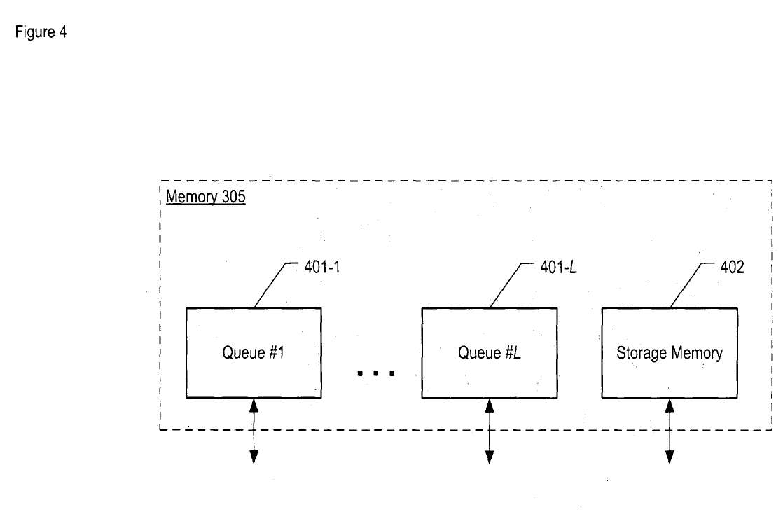

Memory 305 comprises queues 401-i, for i=1 to L, wherein L is a positive integer, and storage memory 402, depicted in FIG. 4 and described in detail below.

Queues 401-i, for i=1 to L, are each first-in, first-out memories. Each of queues 401-1 through 401-L are uniquely associated with application i, which is associated with a class of service. In accordance with the illustrative embodiment, each class of service is associated with one or more quality-of-service parameters (e.g., minimum throughput, maximum latency, etc.).

Each of queues 401-1 through 401-L holds a portion of a frame pending transmission by lower layer entity 202 on the shared communications channel. It will be clear to those skilled in the art how to make and uses queues 401-1 through 401-L.

Storage memory 402 stores a description for each frame being processed by lower layer entity 202. The description comprises one or more of the following characteristics:

i. frame length, or

ii. a first transmission rate associated with the frame, or

iii. class of service associated with the frame, or

iv. a second transmission rate associated with the frame, or

v. at least one form of modulation (e.g., orthogonal frequency division multiplexing, etc.) associated with the frame.

The description needs to comprise sufficient information to permit lower layer entity 202 to determine the suitability of each queued frame portion when responding to a transmission opportunity or scheduled transmission time slot. It will be clear to those skilled in the art how to represent these characteristics in storage memory 402 for each frame.

In some embodiments, queue 401-i, instead of storage memory 402, stores the description of the frame associated with application i.

Transmitter 306 is a circuit that is capable of receiving frames from processor 303, in well-known fashion, and of transmitting them on the shared-communications channel.

FIG. 5 depicts a flowchart of the salient tasks performed by the illustrative embodiment of the present invention. It will be clear to those skilled in the art which tasks depicted in FIG. 5 can be performed simultaneously or in a different order than that depicted.

At task 501, lower layer entity 202 stores a description of a first frame received from upper unit 201.

At task 502, lower layer entity 202 receives a first portion of the first frame. The length of the first portion (e.g., in bits, octets, etc.) is less than or equal to the length of the frame and is based on a first transmission rate that is part of the description of the frame.

At task 503, lower layer entity 202 queues the first portion of the first frame into queue 401-i for application i. The portion of the frame that is queued is referred to as a “partial queue entry.”

Because lower layer entity 202 operates in accordance with IEEE 802.11, lower layer entity 202 becomes aware of a transmission opportunity in accordance with a coordination function (e.g., the distributed coordination function, the extended distributed coordination function, the point coordination function, etc.). It will be clear to those skilled in the art how to make and use embodiments of the present invention that use different medium access control protocols.

Processor 303 continually determines from which one of queues 401-1 through 401-L to next draw frame portions at the next transmission opportunity. In other words, conceptually queues 401-1 through 401-L in lower layer entity 202 are vying with each other for transmission opportunities. By using the characteristics constituting the frame description stored in memory 305, processor 303 can make the decision of what frame portion to transmit from which of queues 401-1 through 401-L without a need for real-time intervention with or response from upper layer entity 201. For example, the queue whose frames are to be transmitted at the next transmission opportunity can be based on,

i. a round robin scheme, or

ii. a random scheme, or

iii. the size of the partial queue entry in queue 401-i, or

iv. the latency tolerance of application i, or

v. the throughput requirements of application i.

It will be clear to those skilled in the art how to coordinate the selection of frames from queues 401-1 through 401-L.

At task 504, lower layer entity 202 removes from queue 401-i the first portion of the first frame and transmits the first portion, as a contention-free burst, into the shared-communications channel, in well-known fashion.

At task 505, lower layer entity 202 receives a second portion of the first frame after the transmission of the first portion has started. The second portion is known to exist based on the frame length stored as part of the description of the first frame or based on some other suitable indication.

Lower layer entity 202 ultimately queues, removes, and transmits the second portion of the first frame in similar fashion as with the first portion. Real-time response on the part of upper layer entity 201 is only required for supplying the remaining frame portions after lower layer entity 202 has chosen a frame to transmit and has initiated transmission of the frame.

If a second frame follows the first frame, lower layer entity 202 stores a description for the second frame and receives a first portion of the second frame. In some embodiments, the length of the first portion of the second frame is based on the transmission rate governing the first frame, even though the first portion of the second frame might be governed by a different transmission rate. Eventually, lower layer entity 202 removes the description of the first frame from memory 305.

The amount of data that needs to be stored in each partial queue entry is causally related to the latency time upper-lower layer interface 201 multiplied by the physical layer data rate of the transmission into the shared-communications channel. Consequently, some embodiments of the present invention provide a reduction in the memory required to maintain multiple queues for servicing quality of service polls in the medium access controller protocol.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
storing a description of a first frame wherein said description comprises:
(1) a frame length; and
(2) a first transmission rate;
receiving a first portion of said first frame wherein the length of said first portion is less than said frame length and is based on said first transmission rate;
queuing said first portion of said first frame;
transmitting said first portion of said first frame at said first transmission rate into a shared-communications channel; and
receiving a second portion of said first frame after said transmission of said first portion has started.

2. The method of claim 1 wherein said description further comprises a second transmission rate and at least one form of modulation.

3. The method of claim 2 wherein said at least one form of modulation comprises orthogonal frequency division multiplexing.

4. The method of claim 1 further comprising queuing said second portion of said first frame wherein the length of said second portion is less than said frame length, and is based on said first transmission rate and the time required to receive said second portion.

5. A apparatus comprising:
an interface controller for:
(1) receiving a first portion of a first frame; and
(2) receiving a second portion of a first frame;
a memory for:
(1) storing a description of said first frame wherein said description comprises a frame length and a first transmission rate; and
(2) queuing said first portion of said first frame wherein the size of said queue is based on said first transmission rate and the time required to receive said first portion; and
a transmitter for transmitting said first portion of said first frame at said first transmission rate into a shared-communications channel.

6. The apparatus of claim 5 wherein said description further comprises a second transmission rate and at least one form of modulation.

7. The apparatus of claim 6 wherein said at least one form of modulation comprises orthogonal frequency division multiplexing.

8. The apparatus of claim 5 wherein said memory is also for queuing said second portion of said first frame wherein the length of said second portion is less than said frame length, and is based on said first transmission rate and the time required to receive said second portion.

9. The apparatus of claim 5 wherein said transmitter operates in accordance with the IEEE 802.11 air interface protocol.

10. A method comprising:
storing a first description wherein said first description comprises:
(1) a first frame length; and
(2) a first transmission rate;
transmitting a queued portion of a first frame at said first transmission rate into a shared-communications channel;
removing said queued portion of said first frame wherein said removal is based on said first frame length;
storing a second description wherein said second description comprises:
(1) a second frame length; and
(2) a second transmission rate;
queuing a first portion of a second frame wherein the length of said first portion is less than said second frame length and is based on said first transmission rate; and
transmitting said first portion of said second frame at said second transmission rate into said shared-communications channel.

11. The method of claim 10 wherein said first transmission rate and said second transmission rate are different.

12. The method of claim 10 further comprising queuing a second portion of said second frame wherein the length of said second portion is less than said second frame length and is based on said second transmission rate.

13. An apparatus comprising:
a memory for:
(1) storing a first description wherein said first description comprises a first frame length and a first transmission rate;
(2) storing a second description wherein said second description comprises a second frame length and a second transmission rate; and
(3) queuing a first portion of a second frame wherein the length of said first portion is less than said second frame length and is based on said first transmission rate;
a transmitter for:
(1) transmitting a queued portion of a first frame at said first transmission rate into a shared-communications channel; and
(2) transmitting said first portion of said second frame at said second transmission rate into said shared-communications channel; and
a processor for removing said first description and said queued portion of said first frame wherein said removal is based on said first frame length.

14. The apparatus of claim 13 wherein said first transmission rate and said second transmission rate are different.

15. The apparatus of claim 13 wherein said memory is also for queuing a second portion of said second frame wherein the length of said second portion is less than said second frame length and is based on said second transmission rate.

16. The apparatus of claim 13 wherein said transmitter operates in accordance with the IEEE 802.11 air interface protocol.

17. A method comprising:
storing a first description of a first frame wherein said first description comprises:
(1) a first frame length;
(2) a first transmission rate; and
(3) a first class of service with which said first frame is associated;
queuing a first portion of said first frame in a first queue wherein said first portion of said first frame comprises m octets, wherein m is a positive integer, and wherein the value of m is based on said first transmission rate;
transmitting said first portion of said first frame at said first transmission rate into a shared-communications channel;
receiving a second portion of said first frame after said transmission of said first portion has started;
storing a second description of a second frame after said storing of said first description wherein said second description comprises:
(1) a second frame length;
(2) a second transmission rate; and
(3) said second class of service with which said second frame is associated;
queuing a portion of said second frame wherein said portion of said second frame comprises n octets, wherein n is a positive integer, and wherein the value of n is based on said second transmission rate; and
transmitting said portion of said second frame at said second transmission rate into said shared-communications channel.

18. The method of claim 17 wherein said first transmission rate and said second transmission rate are different.

19. The method of claim 17 further comprising queuing a second portion of said second frame wherein the length of said second portion is less than said second frame length and is based on said second transmission rate.

20. The method of claim 17 wherein said transmitting is performed in accordance with the IEEE 802.11 air interface protocol.
